(19) United States
(12) Patent Application Publication
(10) Pub. No.: US 2018/0154626 A1
(43) Pub. Date: Jun. 7, 2018

(54) COMPONENTS WITH INTEGRAL HARDWARE AND METHOD OF MANUFACTURING SAME

(71) Applicant: ARCONIC INC., Pittsburgh, PA (US)

(72) Inventors: Luke Haylock, Culver City, CA (US); Manish Kamal, Seal Beach, CA (US); Rodrigo Pinheiro, Riverside, CA (US); Wudhidham Prachumsri, Torrance, CA (US); Adam Travis, Pittsburgh, PA (US)

(73) Assignee: ARCONIC INC., Pittsburgh, PA (US)

(21) Appl. No.: 15/828,667

(22) Filed: Dec. 1, 2017

Related U.S. Application Data
(60) Provisional application No. 62/428,817, filed on Dec. 1, 2016.

(51) Int. Cl. B33Y 10/00; B22F 3/105; B33Y 80/00; B21D 53/24; B21D 53/16

(52) U.S. Cl. CPC B33Y 10/00; B22F 3/1055; B21D 53/16; B21D 53/24; B33Y 80/00

(57) ABSTRACT

A component including a wall with a first surface, a second surface opposite the first surface, and at least one aperture formed within the wall and extending from the first surface to the second surface. At least one boss is located on the first surface of the wall and around the at least one aperture, the at least one boss being constructed by layered, additive manufacturing. Optionally, the aperture need not be included. A method including the steps of providing a component having a wall with a first surface, a second surface opposite the first surface, and at least one aperture formed within the wall and extends from the first surface to the second surface thereof, and constructing at least one boss on the first surface of the wall of the component and around the at least one aperture using layered, additive manufacturing.

### CROSS-REFERENCE TO RELATED APPLICATION

This application is a § 111(a) application and relates to and claims the benefit of commonly-owned, co-pending U.S. Provisional Patent Application Ser. No. 62/428,817, filed Dec. 1, 2016, entitled “METHOD OF FABRICATING COMPONENTS WITH INTEGRAL HARDWARE,” the contents of which are incorporated herein by reference in its entirety.

### FIELD OF THE INVENTION

The present invention relates to components with integral hardware and a method of manufacturing such components.

### BACKGROUND OF THE INVENTION

Seamless components, for example, rings, are used for static turbine engine components, such as diffusers and cases, such as compressor cases, combustor cases, and turbine cases. Seamless rings, which are fabricated by a combination of forging and rolling, vary in diameter from several inches to several feet. Most turbine cases include features such as bosses and pads on the surfaces for attaching injectors, sensors, generators, and cables to the surface of the case. These surface features must withstand the same harsh environment as other portions of the case. Typically, these features are created by machining the entire case from a rolled ring with excess material thickness.

When a case including boss and pad features are machined out, holes are drilled and tapped, and special fasteners called inserts or studs are then threaded into these tapped holes. Drilling and tapping a hole on a large curved surface of a ring with accuracy is inherently challenging. Additionally, since super-alloys are commonly used to make the ring, this further increases the difficulty of machining such features. Machinists often invest significant time and resources machining a case only to reject the ring in the final stages of machining due to a faulty hole drilling/tapping or a faulty fastener installation as a result of improper drilling/tapping.

### SUMMARY OF THE INVENTION

In an embodiment, a method, comprising the steps of providing a component having a wall with a first surface and a second surface opposite the first surface; and constructing at least one boss on the first surface of the wall of the component using layered, additive manufacturing. In an embodiment, the at least one boss includes a construct that is constructed using the layered, additive manufacturing. In an embodiment, the construct is constructed from a plurality of layers of material, such that a first layer of the plurality of layers of material is deposited on the first surface of the wall of the component, and a second layer of the plurality of layers of material is deposited on the first layer of the material. In an embodiment, the plurality of layers of material includes more than two layers of the material, and wherein each layer of material deposited subsequent to the second layer of material is deposited on an immediate prior deposited layer of material.

In an embodiment, the first surface is an exterior surface and the second surface is an interior surface. In an embodiment, the first surface is an interior surface and the second surface is an exterior surface.

In an embodiment, each of the plurality of layers of the material is made of a metallic material. In an embodiment, the metallic material is selected from the group consisting of steel, stainless steel, aluminum, aluminum alloy, cobalt alloy, nickel alloy, and titanium alloy. In an embodiment, each of the plurality of layers of the material is made of a composite material.

In an embodiment, the construction step includes welding. In an embodiment, the construction step includes a raster process. In an embodiment, the construction step includes electronic beam additive manufacturing. In an embodiment, the construction step includes induction heating. In an embodiment, the construction step includes sintering. In an embodiment, the sintering step includes selective laser sintering. In an embodiment, the sintering step includes direct metal laser sintering. In an embodiment, the construction step includes selective laser melting. In an embodiment, the construction step includes directed energy deposition. In an embodiment, the construction step includes cold spraying.

In an embodiment, the wall includes at least one aperture formed therein and extends from the first surface to the second surface thereof, wherein the construct is constructed around the at least one aperture, and wherein each of the plurality of layers of the material includes an outer end located distal from the aperture and having a first thickness, and an inner end located proximate to the aperture and having a second thickness. In an embodiment, the first thickness is greater than the second thickness. In an embodiment, the first thickness is less than the second thickness. In an embodiment, the first thickness is equal to the second thickness.

In an embodiment, the construct includes at least one hole having internal threads. In an embodiment, the hole is sized and shaped to receive a threaded insert. In an embodiment, the hole is sized and shaped to receive a stud.

In an embodiment, the method further comprises the step of finish-machining the at least one boss. In an embodiment, the at least one boss includes a plurality of bosses. In an embodiment, the component is a ring.

In an embodiment, a component, comprising a wall with a first surface and a second surface opposite the first surface; and at least one boss located on the first surface of the wall of the component, the at least one boss being constructed by layered, additive manufacturing. In an embodiment, the at least one boss includes a construct that is constructed using the layered, additive manufacturing. In an embodiment, the construct includes a plurality of layers of material, such that a first layer of the plurality of layers of material is deposited on the first surface of the wall of the component, and a second layer of the plurality of layers of material is deposited on the first layer of the material. In an embodiment, the plurality of layers of material includes more than two layers of the material, and wherein each layer of material deposited subsequent to the second layer of material is deposited on an immediate prior deposited layer of material.

In an embodiment, the first surface is an exterior surface and the second surface is an interior surface. In an embodiment, the first surface is an interior surface and the second surface is an exterior surface.

In an embodiment, each of the plurality of layers of the material are made of a metallic material. In an embodiment, the metallic material is selected from the group consisting of steel, stainless steel, aluminum, aluminum alloy, cobalt alloy, nickel alloy, and titanium alloy. In an embodiment, each of the plurality of layers of the material are made of a composite material.

In an embodiment, the wall includes at least one aperture formed therein and extends from the first surface to the second surface thereof, wherein the construct is constructed around the at least one aperture, and wherein each of the plurality of layers of the material includes an outer end located distal from the aperture and having a first thickness, and an inner end located proximate to the aperture and having a second thickness. In an embodiment, the first thickness is greater than the second thickness. In an embodiment, the first thickness is less than the second thickness. In an embodiment, the first thickness is equal to the second thickness.

In an embodiment, the construct includes at least one hole having internal threads. In an embodiment, the hole is sized and shaped to receive a threaded insert. In an embodiment, the hole is sized and shaped to receive a stud. In an embodiment, the at least one boss includes a plurality of bosses. In an embodiment, the component is a ring.

The component and associated method of making same of the present invention is advantageous over prior art components and methods in that the receptacles are constructed on the wall thereof by layered, additive manufacturing, which eliminates many problems and errors that result from directly machining same.

### BRIEF DESCRIPTION OF THE DRAWINGS

FIGS. 1A through 1C show an embodiment of the steps of a method of making a ring with inserts using an additive manufacturing process; FIG. 1D is an enlarged view of an embodiment of a boss employed by the ring; and FIG. 1E shows a sectional view, taken along section line 1E-1E and looking in the direction of the arrows, of the boss shown in FIG. 1D;

FIG. 2 shows a top perspective view of the boss shown in FIGS. 1D and 1E, with inserts produced by the method of the present invention, the left side of which having been machined;

FIG. 3 shows a sectional view of a boss feature with inserts, the boss having been added via additive manufacturing; and

FIG. 4 shows another embodiment of a boss fabricated on a ring using an alternate method of adding the boss to the ring via additive manufacturing.

### DETAILED DESCRIPTION OF THE DRAWINGS

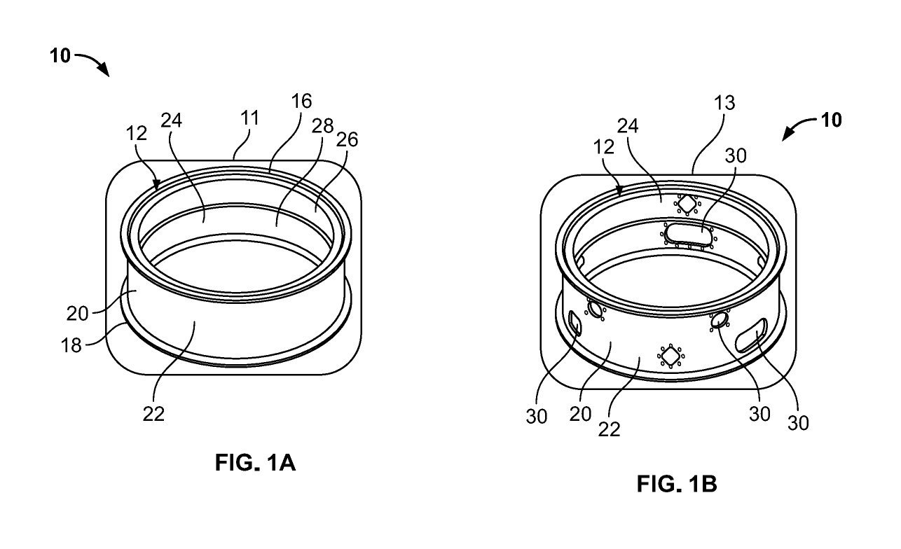

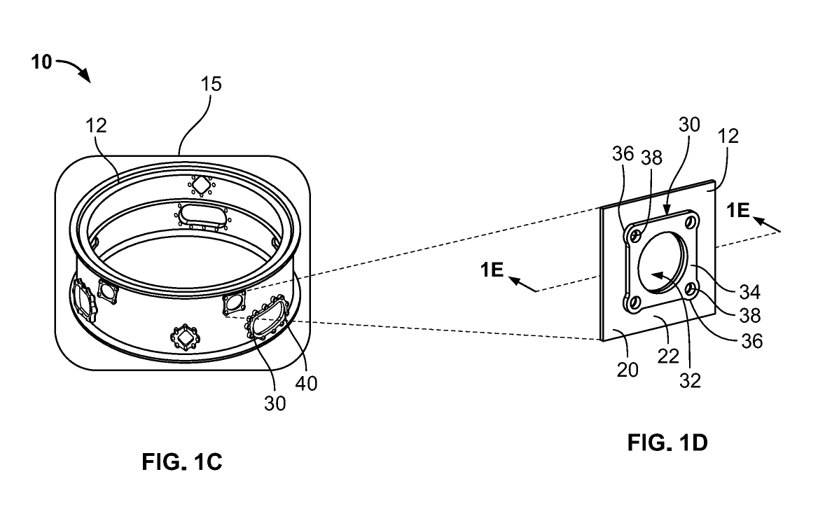

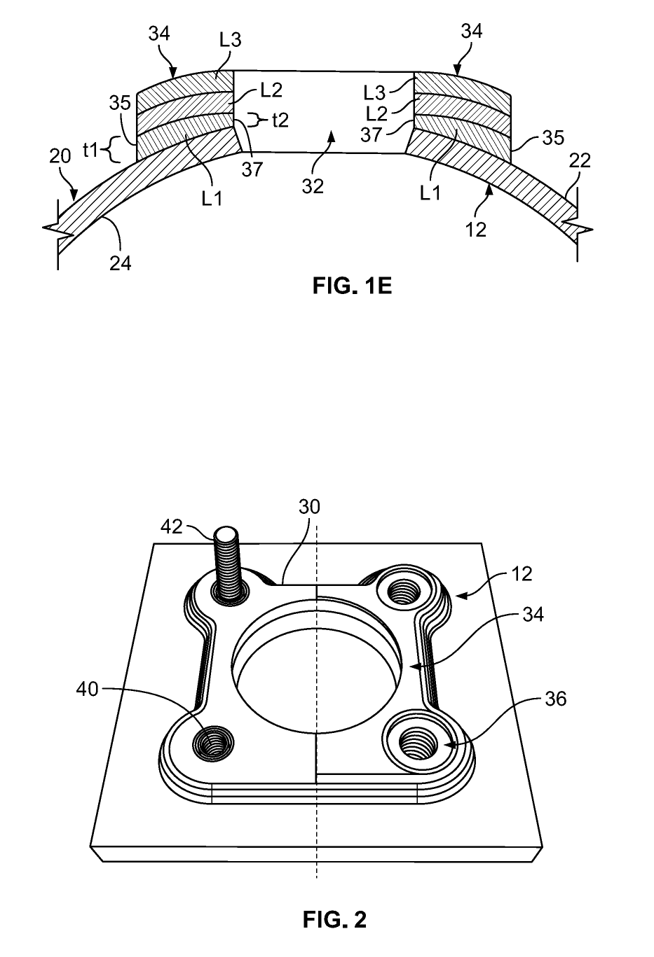

FIGS. 1A through 1C show an embodiment of a method 10 of fabricating a component having integral hardware that is constructed using a layered, additive manufacturing process. In certain embodiments, the component is a turbine engine case, a compressor case, or a combustor case, or other types of engine cases, with integral bosses having integral fasteners and/or receptacles. In other embodiments, the component is any other type of component with integral hardware. In an embodiment, the case includes a thin-walled ring 12. In an embodiment, the ring 12 is utilized as a backbone for manufacturing the case. In another embodiment, the case is manufactured directly onto or within a structure. In an embodiment, the ring 12 is made of metal. In an embodiment, the ring 12 is made of steel. In an embodiment, the ring 12 is made of stainless steel. In an embodiment, the ring 12 is made of aluminum. In another embodiment, the ring 12 is made of an aluminum alloy. In an embodiment, the ring 12 is made of a cobalt alloy. In an embodiment, the ring 12 is made of a nickel alloy. In an embodiment, the ring 12 is made of a titanium alloy. In an embodiment, the ring 12 is made of a composite material.

Still referring to FIGS. 1A through 1C, and specifically to FIG. 1A, the method 10 includes the step 11 of providing the ring 12 which includes a first end 16, a second end 18 opposite the first end 16, and a wall 20 extending from the first end 16 to the second end 18. In an embodiment, the wall 20 includes an exterior surface 22 and an interior surface 24 opposite the exterior surface 22. In an embodiment, the interior surface 24 of the wall 20 includes a plurality of sections 26, 28 extending circumferentially and having different inner diameters from one another. In another embodiment, the plurality of sections 26, 28 includes more than the two sections 26, 28. In another embodiment, the wall 20 need not include the plurality of sections 26, 28 having different inner diameters and the wall 20 can include a single, substantially constant inner diameter.

Referring specifically to FIG. 1B, in an embodiment, the method 10 includes the step 13 of adding a boss 30 to the ring 12 by utilizing an additive manufacturing process. In an embodiment, the ring 12 includes at least one boss 30. In an embodiment, the at least one boss 30 includes a plurality of bosses 30, as shown in FIG. 1B. In an embodiment, any one of the bosses 30 can be a stud boss. In an embodiment, any one of the bosses 30 can be an insert boss.

In an embodiment, the boss 30 includes an aperture 32 extending from the exterior surface 22 to the interior surface 24 of the wall 20. In an embodiment, the aperture 32 is machined within the wall 20 of the ring 12. In an embodiment, the boss 30 includes a construct 34 (also known as and sometimes referred to herein as a “pad”), which is constructed around the aperture 32 by a layered, additive manufacturing process. In this regard, in an embodiment, material for constructing the construct 34 is added on the exterior surface 22 of the wall 20 around the aperture 32 one layer at a time. Referring to FIG. 1E, a first layer L1 is deposited and formed on the exterior surface 22 of the wall 20 of the ring 12, a second layer L2 is then deposited and formed on the first layer L1, a third layer L3 is then deposited and formed on the second layer L2, and so on, until the construct 34 is formed in its entirety. It is understood that the layers L1-L3 may include more (or less) than the three layers L1-L3. In an embodiment, the layers L1-L3 of the construct 34 are each made of any metallic material that can be melted. In an embodiment, the layers L1-L3 of the construct 34 are each made of steel. In an embodiment, the layers L1-L3 of the construct 34 are each made of stainless steel. In an embodiment, the layers L1-L3 of the construct 34 are each made of aluminum. In another embodiment, the layers L1-L3 of the construct 34 are each made of an aluminum alloy. In an embodiment, the layers L1-L3 of the construct 34 are each made of a cobalt alloy. In an embodiment, the layers L1-L3 of the construct 34 are each made of a nickel alloy. In an embodiment, the layers L1-L3 of the construct 34 are each made of a titanium alloy. In an embodiment, the layers L1-L3 are each made of a composite material.

In an embodiment, each of the layers L1-L3 of the construct 34 are deposited and formed by a welding process. In another embodiment, each of the layers L1-L3 are deposited and formed by a raster process. In another embodiment, each of the layers L1-L3 are deposited and formed by an electronic beam additive manufacturing process. In another embodiment, each of the layers L1-L3 are deposited and formed by induction heating. In another embodiment, each of the layers L1-L3 are deposited and formed by metal sintering or melting, such as selective laser sintering, direct metal laser sintering, or selective laser melting. In another embodiment, each of the layers L1-L3 is deposited and formed by directed energy deposition. In another embodiment, each of the layers L1-L3 is deposited and formed by cold spraying.

Referring to FIG. 1E, in an embodiment, because the exterior surface 22 of the wall 20 of the ring 12 is convex in shape, each of the layers L1-L3 has a thickness t1 at outer ends 35 thereof (i.e., distal from the aperture 32) that is greater than a thickness t2 at inner sides 37 thereof (i.e., proximate to the aperture 32). In another embodiment, the thickness t1 of each of the layers L1-L3 is less than the thickness t2 thereof. In another embodiment, the thickness t1 of each of the layers L1-L3 is equal to the thickness t2 thereof. Referring to FIG. 1D, in an embodiment, the construct 34 includes preformed insert holders/receptacles 36 for preparing tapped holes 38 during the aforesaid layering process of the boss addition step 13. In an embodiment, the holes 38 are threaded holes, each of which includes a plurality of internal threads.

In other embodiments, the boss 30 can be constructed on the interior surface 24 of the wall 20 such that the construct 34 is constructed around the aperture 32 by the aforesaid layered, additive manufacturing process (not shown in the Figures). It is understood that because the interior surface 24 of the wall 20 of the ring 12 is concave in shape, each of the layers L1-L3 has a thickness t1 at outer ends 35 thereof (i.e., distal from the aperture 32) that is less than a thickness t2 at inner sides 37 thereof (i.e., proximate to the aperture 32). In another embodiment, the thickness t1 of each of the layers L1-L3 is greater than the thickness t2 thereof. In another embodiment, the thickness t1 of each of the layers L1-L3 is equal to the thickness t2 thereof.

In other embodiments, the boss 30 need not include the at least one aperture 32. In this regard, the boss 30 is solid and is constructed on the wall 20.

Referring back to FIG. 1C, in step 15 of the method 10, the boss 30 is finish-machined to meet specified surface finish requirements. In an embodiment, as shown in FIGS. 1C and 2, inserts 40 and/or studs 42 are added to the boss 30 after machining. Since the boss 30 has already been prepared to accept the inserts 40 and the studs 42, installation thereof is relatively quick and easy and reduces the risk associated with preparing the tapped holes 38 to accept the inserts 40 and the studs 42.

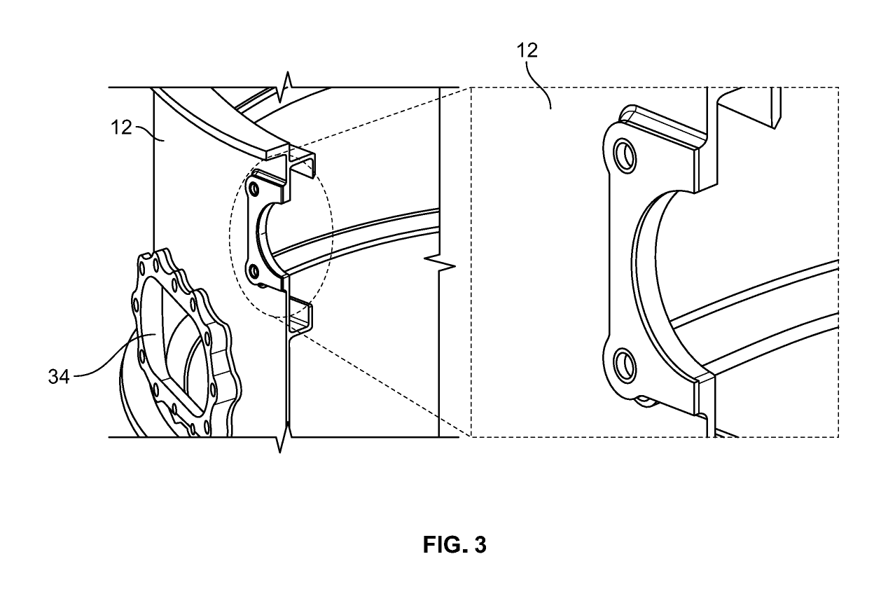

In certain instances, there is a concern regarding the heat affected zone (HAZ) from the additive manufacturing process near the constructs 34. Referring to FIG. 3, an example of a technique that can be used to manage the HAZ is shown. Here, the transition zone for the construct 34 comes from the base ring 12 material and the bosses 30 are added on using the additive manufacturing process. The additive manufacturing process can be managed such that the HAZ is in the transition zone and does not affect the nominal thickness of the ring.

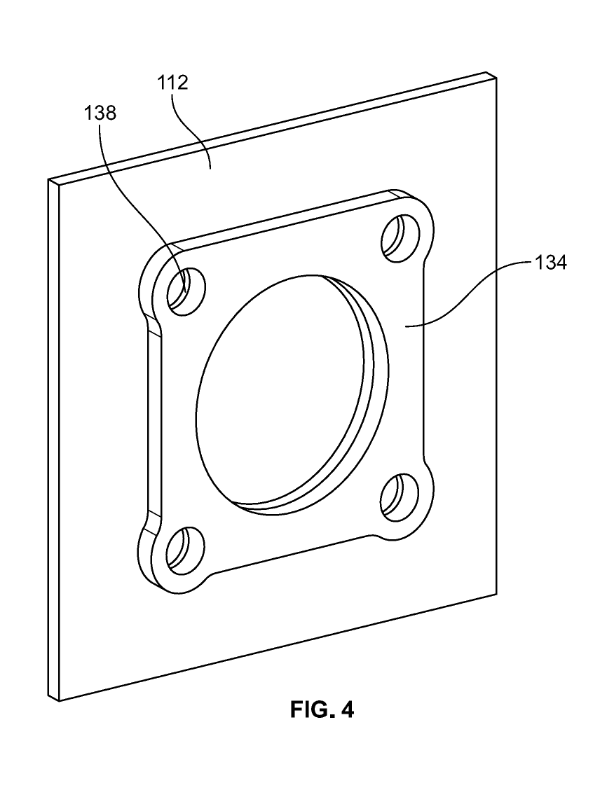

FIG. 4 shows another embodiment of a result of a method of fabricating a turbine engine component. In an embodiment, a construct/protuberance part 134 containing holes 138 and/or inserts using additive manufacturing is provided. The same concept can be applied another way where the entire construct part 134 is created separately and prepared to accept the inserts or studs. This entire construct part 134 is added via additive manufacturing to a base ring 112. This approach is best suited for small features such as a construct 134 which houses a single insert.

With each of the aforesaid methods, existing inserts 40 and/or studs 42 with locking features can be used in conjunction with the ring 12. In an embodiment, the inserts 40 and the studs 42 are removable for replacement or repair using existing techniques. It is also recognized that the methods described above are not inherently limited to the inserts 40 and the studs 42; the methods can be used to add other types of hardware to the ring 12, such as bearings, bearing journals, bushings, inspections ports, or sensors. In other embodiments, the methods described above can be utilized in conjunction with components other than the ring 12. In an embodiment, the methods described above can reduce the ratio between the weight of the input material and the finished part weight to approximately 3 to 1.

It should be understood that the embodiments described herein are merely exemplary and that a person skilled in the art may make many variations and modifications without departing from the spirit and scope of the invention. All such variations and modifications are intended to be included within the scope of the invention as exemplified by the appended claims.

What is claimed is:

1. A method, comprising the steps of:
providing a component having a wall with a first surface and a second surface opposite the first surface; and
constructing at least one boss on the first surface of the wall of the component using layered, additive manufacturing.

2. The method of claim 1, wherein the at least one boss includes a construct that is constructed using the layered, additive manufacturing.

3. The method of claim 2, wherein the construct is constructed from a plurality of layers of material, such that a first layer of the plurality of layers of material is deposited on the first surface of the wall of the component, and a second layer of the plurality of layers of material is deposited on the first layer of the material.

4. The method of claim 3, wherein the plurality of layers of material includes more than two layers of the material, and wherein each layer of material deposited subsequent to the second layer of material is deposited on an immediate prior deposited layer of material.

5. The method of claim 3, wherein each of the plurality of layers of the material is made of a metallic material.

6. The method of claim 5, wherein the metallic material is selected from the group consisting of steel, stainless steel, aluminum, aluminum alloy, cobalt alloy, nickel alloy, and titanium alloy.

7. The method of claim 3, wherein each of the plurality of layers of the material is made of a composite material.

8. The method of claim 3, wherein the construction step includes welding.

9. The method of claim 3, wherein the construction step includes a raster process.

10. The method of claim 3, wherein the construction step includes electronic beam additive manufacturing.

11. The method of claim 3, wherein the construction step includes induction heating.

12. The method of claim 3, wherein the construction step includes sintering.

13. The method of claim 12, wherein the sintering step includes selective laser sintering.

14. The method of claim 12, wherein the sintering step includes direct metal laser sintering.

15. The method of claim 3, wherein the construction step includes selective laser melting.

16. The method of claim 3, wherein the wall includes at least one aperture formed therein and extends from the first surface to the second surface thereof, wherein the construct is constructed around the at least one aperture, and wherein each of the plurality of layers of the material includes an outer end located distal from the aperture and having a first thickness, and an inner end located proximate to the aperture and having a second thickness.

17. The method of claim 16, wherein the first thickness is greater than the second thickness.

18. The method of claim 3, wherein the construct includes at least one hole having internal threads.

19. The method of claim 18, wherein the hole is sized and shaped to receive a threaded insert.

20. The method of claim 18, wherein the hole is sized and shaped to receive a stud.

21. The method of claim 1, further comprising the step of finish-machining the at least one boss.

22. The method of claim 1, wherein the at least one boss includes a plurality of bosses.

23. The method of claim 1, wherein the component is a ring.

24. A component, comprising a wall with a first surface and a second surface opposite the first surface; and at least one boss located on the first surface of the wall of the component, the at least one boss being constructed by layered, additive manufacturing.

25. The component of claim 24, wherein the at least one boss includes a construct that is constructed using the layered, additive manufacturing.

26. The component of claim 25, wherein the construct includes a plurality of layers of material, such that a first layer of the plurality of layers of material is deposited on the first surface of the wall of the component, and a second layer of the plurality of layers of material is deposited on the first layer of the material.

27. The component of claim 26, wherein the plurality of layers of material includes more than two layers of the material, and wherein each layer of material deposited subsequent to the second layer of material is deposited on an immediate prior deposited layer of material.

28. The component of claim 27, wherein each of the plurality of layers of the material is made of a metallic material.

29. The component of claim 28, wherein the metallic material is selected from the group consisting of steel, stainless steel, aluminum, aluminum alloy, cobalt alloy, nickel alloy, and titanium alloy.

30. The component of claim 26, wherein each of the plurality of layers of the material are made of a composite material.

31. The component of claim 26, wherein the wall includes at least one aperture formed therein and extends from the first surface to the second surface thereof, wherein the construct is constructed around the at least one aperture, and wherein each of the plurality of layers of the material includes an outer end located distal from the aperture and having a first thickness, and an inner end located proximate to the aperture and having a second thickness.

32. The component of claim 31, wherein the first thickness is greater than the second thickness.

33. The component of claim 26, wherein the construct includes at least one hole having internal threads.

34. The component of claim 33, wherein the hole is sized and shaped to receive a threaded insert.

35. The component of claim 33, wherein the hole is sized and shaped to receive a stud.

36. The component of claim 24, wherein the at least one boss includes a plurality of bosses.

37. The component of claim 24, wherein the component is a ring.

38. The component of claim 24, wherein the first surface is an exterior surface and the second surface is an interior surface.

39. The component of claim 24, wherein the first surface is an interior surface and the second surface is an exterior surface.

40. The method of claim 1, wherein the first surface is an exterior surface and the second surface is an interior surface.

41. The method of claim 1, wherein the first surface is an interior surface and the second surface is an exterior surface.

42. The method of claim 3, wherein the construction step includes directed energy deposition.

43. The method of claim 3, wherein the construction step includes cold spraying.

44. The method of claim 16, wherein the first thickness is less than the second thickness.

45. The method of claim 16, wherein the first thickness is equal to the second thickness.

46. The component of claim 24, wherein the first thickness is less than the second thickness.

47. The component of claim 24, wherein the first thickness is equal to the second thickness.
